(19) United States
(12) Patent Application Publication
(10) Pub. No.: US 2024/0253918 A1
(43) Pub. Date: Aug. 1, 2024

(54) REAR HEADERS FOR DOCK LEVELERS

(71) Applicant: Rite-Hite Holding Corporation, Milwaukee, WI (US)

(72) Inventor: Leonard John Kikstra, Sussex, WI (US)

(21) Appl. No.: 18/421,752

(22) Filed: Jan. 24, 2024

Related U.S. Application Data
(60) Provisional application No. 63/482,517, filed on Jan. 31, 2023.

(51) Int. Cl. B65G 69/28

(52) U.S. Cl. CPC B65G 69/2811

(57) ABSTRACT

Rear headers for dock levelers. An example dock leveler includes a deck movable between a stored position and an operating position; and a rear header coupled to the deck, the rear header including a hinge lug; a mounting plate to couple to the hinge lug, the mounting plate defining a first sloped surface oriented toward a rear surface of the deck when the dock leveler is in the stored position; and a tilt plate coupled to the mounting plate, the tilt plate defining a second sloped surface oriented away from the rear surface of the deck when the dock leveler is in the stored position.

### CROSS-REFERENCE TO RELATED APPLICATION

This patent claims the benefit of U.S. Provisional Patent Application No. 63/482,517, filed Jan. 31, 2023, which is incorporated by reference herein in its entirety. Priority to U.S. Provisional Patent Application No. 63/482,517 is hereby claimed.

### FIELD OF THE DISCLOSURE

This disclosure relates generally to dock levelers and, more particularly, to rear headers for dock levelers.

### BACKGROUND

Buildings employ loading docks for loading and/or unloading goods between the building and vehicles. A loading dock of a building includes an exterior doorway with an elevated loading dock platform positioned adjacent the doorway.

### BRIEF DESCRIPTION OF THE DRAWINGS

FIG. 1 is a front view of an example loading dock with an example vehicle positioned at a doorway of the loading dock.

FIG. 2 is a cross-sectional side view of the example loading dock of FIG. 1 including an example dock leveler having an example rear header in accordance with teachings of this disclosure. The example dock lever of FIG. 2 is in an example stored position.

FIG. 3 is cross-sectional side view of the example loading dock of FIG. 1 with the example dock leveler in an example cross-traffic position.

FIG. 4 is a perspective view of the example dock leveler of FIGS. 2-3.

FIG. 5A is a partial perspective view of the example dock leveler of FIGS. 2-4.

FIG. 5B is a cross-sectional side view of the example dock leveler of FIGS. 2-4.

FIG. 6 is a partial cross-sectional side view of another example dock leveler having another example rear header disclosed herein.

FIG. 7 is a partial cross-sectional side view of another example dock leveler having yet another example rear header disclosed herein.

FIG. 8A is a perspective view of yet another example rear header disclosed herein.

FIG. 8B is a cross-sectional side view of the example rear header of FIG. 8A.

FIGS. 9A-9D are side views of different example rear headers disclosed herein.

FIGS. 10A-10C are side views of other example rear headers disclosed herein.

FIG. 11A is another example dock leveler disclosed herein.

FIG. 11B is a cross-sectional view of FIG. 11A.

FIG. 12A is a partial perspective view of a known dock leveler.

FIG. 12B is a cross-sectional side view of FIG. 12A.

In general, the same reference numbers will be used throughout the drawing(s) and accompanying written description to refer to the same or like parts. The figures are not to scale. As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

As used herein, the term “substantially perpendicular” encompasses the term perpendicular and more broadly encompasses a meaning whereby a first component is positioned and/or oriented relative to a second component at an absolute angle of no more than five degrees (5°) from perpendicular. For example, a first portion of a first structure (e.g., a mounting plate) that is substantially perpendicular relative to a second structure (e.g., a deck plate) is positioned and/or oriented relative to the second structure at an absolute angle of between 85 degrees and 95 degrees. As used herein, the term “substantially parallel” encompasses the term parallel and more broadly encompasses a meaning whereby a first component is positioned and/or oriented relative to a second component at an absolute angle of no more than five degrees (5°) from parallel. For example, a first structure that is substantially parallel relative to a second structure is positioned and/or oriented relative to the second structure at an absolute angle of between 0 degrees and 5 degrees.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

### DETAILED DESCRIPTION

To compensate for a height difference between a floor of a loading lock and a cargo bed of a vehicle (e.g., a truck or a trailer) located at a doorway of the loading dock, the loading dock typically employs a dock leveler. Dock levelers typically include a deck or ramp pivotally hinged along a rear edge of the deck to vary the height of a front edge of the deck relative to the cargo bed of the vehicle. To span a gap between the front edge of the deck and a rear edge of the cargo bed, the dock lever includes an extension plate or lip that extends outward from the front edge of the deck.

Some example loading docks employ vertically stored dock levelers. A vertically stored dock leveler maintains the deck in a substantially upright position when the dock leveler is in an example stored position. In the stored position, vertically stored dock levelers can enhance safety during maintenance, promote facility cleanliness, and/or provide for environmental control. Unlike a pit-style leveler, vertical levelers (i.e., when in a stored position) allow a door of the loading dock to close directly on a pit floor, which reduces energy loss and/or restricts or prevents infiltration of dust, debris and/or insects inside the loading dock. Further, in some examples, the vertically stored dock levelers can be used to improve security by blocking or restricting access to the loading dock door (e.g., when in the stored position) and thereby reduces points of entry at the loading dock.

However, vertically stored dock levelers can accumulate debris when stored in an example upright or stored position. For instance, vertically stored dock levelers employ rear headers for pivotally coupling the rear edge of the deck to the loading dock. As a result, rear headers are often positioned at an angle relative to a horizontal plane (e.g., relative to the floor of the loading dock). In other words, the rear headers slope or taper in a direction toward the rear edge of the deck (e.g., toward the loading dock wall when in the stored position). As a result, debris can accumulate underneath the deck of the dock leveler. In some instances, debris can accumulate within channels of the dock leveler formed in a lower (e.g., under) region of the deck (e.g., under a deck plate of the deck and between longitudinal support beams of the deck) and between a rear header and the front edge of the deck. As a result, debris projects into a pit area or ground surface of the loading dock when the dock leveler is positioned (e.g., moved) to an operating position (e.g., a horizontal or below horizontal position) from the stored position.

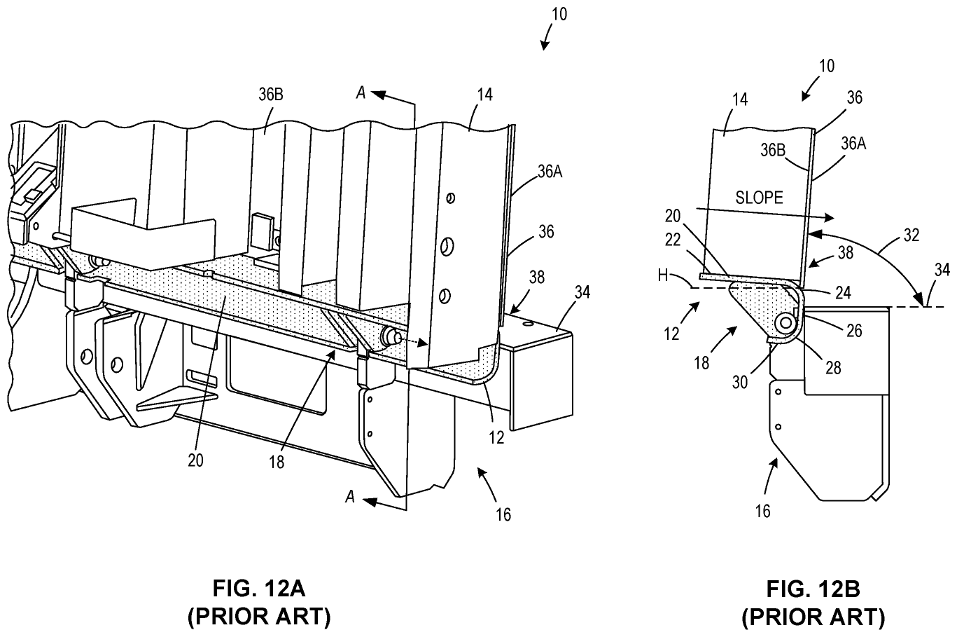

For example, FIG. 12A is a partial perspective view of a known dock leveler 10 having a known rear header 12. FIG. 12B is a cross-sectional side view of the dock leveler 10 taken along line A-A of FIG. 12A. The dock leveler 10 of FIGS. 12A-12B includes a deck 14 pivotally coupled to a frame 16 via a rear hinge assembly 18. The rear hinge assembly 18 includes the rear header 12, which includes a mounting plate 20. The mounting plate 20 is defined by a first portion 22, which is generally straight, a first curve 24 leading to a second portion 26, which is generally straight, and a second curve 28 leading towards a third portion 30, which is generally straight. The mounting plate 20 has a J-shaped cross-section.

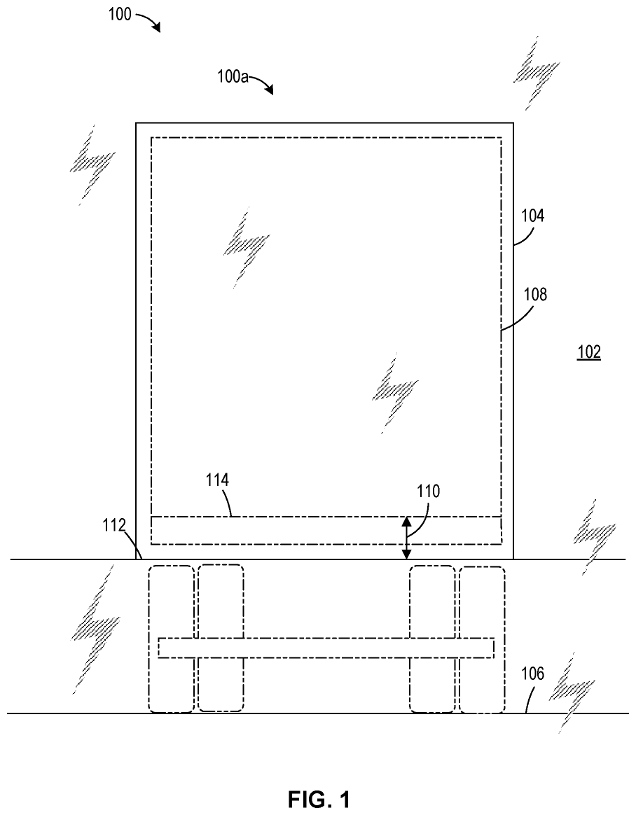

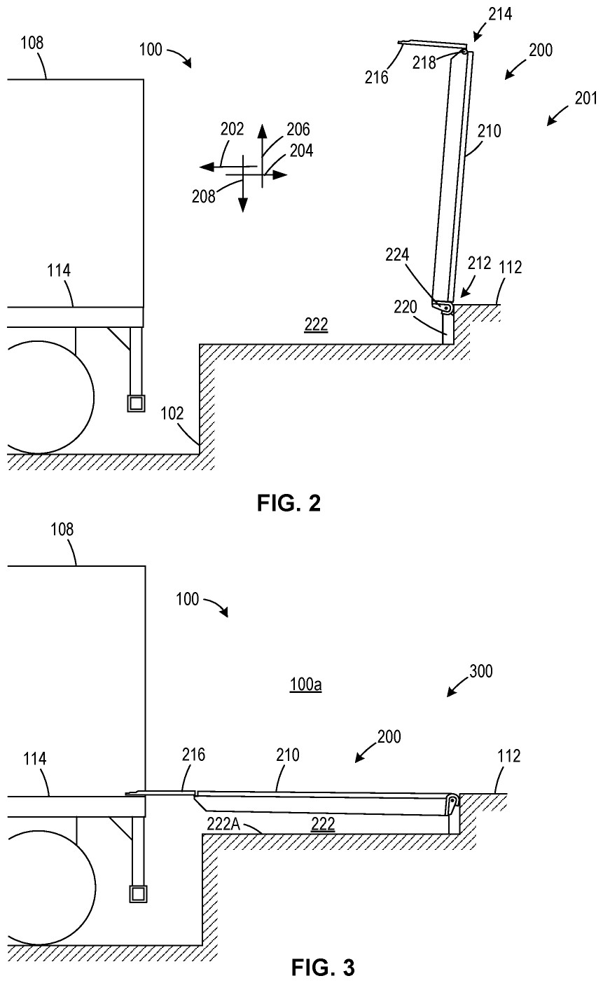

Referring to FIG. 12B, the deck 14 has a slight tilt towards a platform (e.g., loading dock face 102 of FIG. 1, a rearward direction 204 of FIG. 2) when the dock leveler 10 is in a stored position (e.g., the example position shown in FIGS. 12A and 12B). That is, an angle 32 between a loading dock floor 34 (e.g., an upper surface of the floor) and a traffic surface 36A of a deck plate 36 (e.g., an upper surface of the deck plate 36) is at or less than 90 degrees. In some examples, the angle 32 is approximately between 85 degrees and 87 degrees. In other words, the deck 14 is slanted more towards the loading dock floor 34 than a pit floor (e.g., a pit floor 222A of a pit 222 FIGS. 2 and 3) relative to a vertical reference. Such a storage configuration reduces pressure on a hydraulic system that actuates the dock leveler 10, helping prolong equipment life. However, such storage configuration causes the first portion 22 of the rear header 12 to slope relative to horizontal, H. That is, the rear header 12 slopes in a downward and rearward direction (e.g., down and away from the pit 222 and/or toward a rear edge 38 of the deck plate 36). The angled or sloped orientation of the mounting plate 20 (e.g., the first portion 22 of the mounting plate 20) can cause the rear header 12 to accumulate and/or hold debris (e.g., solid debris, caustic cleaning fluid, etc.) when the dock leveler 10 is in a stored position (e.g., a debris catch). As the dock leveler 10 is moved to a lower or cross-traffic position (e.g., a horizontal position relative to a ground surface), the debris can fall on the pit floor 222A.

Example methods, apparatus, and articles of manufacture disclosed herein employ rear headers that prevent or restrict debris accumulation. Example rear headers disclosed herein include a portion that slopes forward (e.g., down and towards a pit of a loading dock) while in a stored or otherwise upright position (e.g., a vertical position relative to ground). For instance, example rear headers disclosed herein are tapered or angled in a direction away from a rear edge of the deck and/or a loading dock floor. In other words, example rear headers disclosed herein have a pitch angle or slope (e.g., a taper) directed to the pit or a ground surface of the loading dock. Example rear headers disclosed herein prevent and/or restrict debris from accumulating and/or storing in the dock leveler to maintain the dock leveler and the pit area relatively clean.

Some example rear headers disclosed herein have a unitary, formed rear header with a forward sloped portion. Example rear headers disclosed herein include an example tapered plate(s). Some example tapered plates disclosed herein can be coupled to a formed rear header. In some examples, tapered plate(s) disclosed herein can be positioned adjacent a rear header between structural support members. Example rear headers disclosed herein employ hinge lugs to enable coupling between the deck and the example tapered plate(s) disclosed herein. In some examples, example tilt (e.g., filler) structures (e.g., foam, a foam pad, a plastic block, etc.) can be positioned on a rear header to provide a forward slope to a rear header (e.g., between channels of an underside of a deck).

FIG. 1 is a front view of an example loading dock 100 in accordance with teachings disclosed herein. The loading dock 100 of the illustrated example includes a dock face 102 (e.g., a building wall) defining a doorway 104 and a driveway 106 to enable a vehicle 108 to access the doorway 104 of the loading dock 100. While a single loading bay 100a is illustrated in FIG. 1, the loading dock 100 can include a plurality of loading bays positioned adjacent the loading bay 100a. As shown in FIG. 1, when the vehicle 108 is parked at the loading dock 100 adjacent the doorway 104, a height differential 110 (e.g., a gap) can exist between a platform or floor 112 of the loading dock 100 and a cargo bed 114 of the vehicle 108 (e.g., truck, trailer, etc.).

FIG. 2 is a side view of the example loading dock 100 of FIG. 1 with an example dock leveler 200 disclosed herein. The dock leveler 200 of the illustrated example is a vertically stored dock leveler. The example dock leveler 200 of FIG. 2 is shown in an example stored position 201 (e.g., a vertical position). To facilitate discussion of the dock leveler 200 in the orientation of FIG. 2, the loading dock 100 is described herein with directional references including an example forward direction 202 (e.g., an outward or horizontal direction away from the dock face 102), an example rearward direction 204 (e.g., an inward or horizontal direction toward to the dock face 102), an example upward direction 206 (e.g., a vertical direction away from the loading dock floor 112), and an example downward direction 208 (e.g., a vertical direction toward to the loading dock floor 112).

The dock leveler 200 of the illustrated example includes an example deck 210 (e.g., deck assembly, platform, etc.) that can pivot about a rear edge 212 to adjust a height of a front edge 214 (e.g., relative to the cargo bed 114 of the vehicle 108). The dock leveler 200 of the illustrated example includes an example lip 216 pivotably coupled to the front edge 214 of the deck 210 via a front hinge assembly 218. To enable the deck 210 to pivot relative to the loading dock floor 112, the dock leveler 200 is pivotally coupled to an example frame 220 that is positioned (e.g., anchored) in a pit 222 of the loading dock 100. Specifically, the rear edge 212 of the deck 210 of the illustrated example is pivotably coupled to the frame 220 via a rear hinge assembly 224. The front hinge assembly 218 at the front edge 214 of the deck 210 and the rear hinge assembly 224 at the rear edge 212 of the deck 210 of the illustrated example enable the dock leveler 200 to adjust and/or compensate for the height differential 110 between the loading dock floor 112 and the vehicle cargo bed 114. In the stored position 201, the deck 210 is in a raised position (e.g., a fully raised position, upright position, vertical position, etc.) and the lip 216 is in a retracted position (e.g., a fully retracted position).

FIG. 3 is a side view of the example loading dock 100 of FIG. 1 shown with the example dock leveler 200 in an example operating position 300 (e.g., a horizontal position). During loading and/or unloading operations, the dock leveler 200 can be moved to various positions relative to the vehicle cargo bed 114 to bridge the gap 110 (FIG. 1) between the vehicle 108 and the loading dock floor 112. Specifically, during loading and/or unloading operations, the loading dock 100 of the illustrated example is positioned in the operating position 300 to provide a transitional surface between the loading dock floor 112 and the cargo bed 114. For example, the deck 210 and lip 216 are movable (pivotable) between a stored (e.g., vertical, retracted, raised, etc.) position 201 (FIG. 2) and the operational position 300 (FIG. 3) (e.g., an extended, lowered, cross-traffic, horizontal position, etc.). In the operational position 300, the deck 210 and the lip 216 together provide an articulated adjustable ramp or bridge to transfer goods between the vehicle cargo bed 114 and the floor 112 of the loading dock 100.

To move the deck 210 and/or the lip 216 between the stored position 201 of FIG. 2 and the operational position 300 of FIG. 3, the dock leveler 200 employs one or more actuators (not illustrated herein). In some examples, the vertically stored dock leveler 200 can be driven by a hydraulic cylinder, linear motors, mechanical linkages, inflatable bladders, springs, and/or combinations thereof, etc. The actuator extends to raise the deck 210 to the vertically stored position 201 (FIG. 2) and retracts as the deck 210 descends to the operative position 300 (FIG. 3). A force for lowering the deck 210 can be generated from the actuator and/or a weight of the deck 210. In some cases, the deck's weight urges the deck downward while a hydraulic flow restriction associated with the cylinder provides the deck 210 with controlled descent. Thus, positioning or angling the deck 210 toward the floor 112 relative to vertical when the deck 210 is in the vertical position 201 further prevents the deck's weight from urging or causing the deck 210 from moving toward the operational position 300.

The pit 222 of the illustrated example is recessed relative to the loading dock floor 112 to provide an area (e.g., a cavity) for the deck 210 to pivot between the stored position 201 of FIG. 2 and the operating position 300 of FIG. 3. In some examples, the pit 222 can form a continuous area (e.g., without separating walls or structures) between the loading bay 100a and a plurality of adjacent loading bays of the loading dock 100. A continuous area forming the pit 222 facilitates cleaning operations of the pit 222 and/or a floor 222A thereof (e.g., for sanitary applications). For example, when the dock leveler 200 is in the stored position 201, the pit 222 is generally open and readily accessible for cleaning.

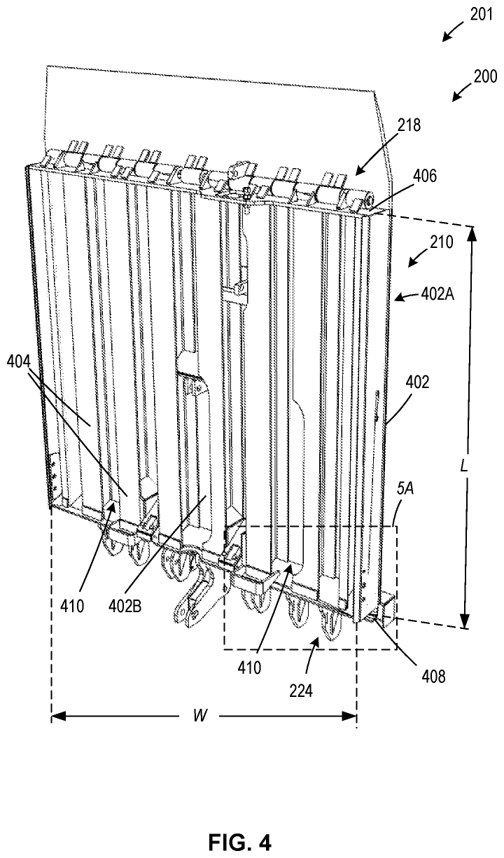

FIG. 4 illustrates the dock leveler 200 of FIGS. 2-3 in the stored position 201 of FIG. 2. In the illustrated example, the deck 210 includes an example deck plate 402, example support members 404 (e.g., support beams, etc.), an example front header 406 to support the front hinge assembly 218, and an example rear header 408 to support the rear hinge assembly 224. The deck plate 402 is defined by a width, W, and a length, L. The deck plate 402 of the illustrated example includes an example first surface 402A that defines a main traffic surface for loading and/or unloading operations between the loading dock 100 and the vehicle 108, and an example second surface 402B opposite the first surface 402A. The second surface 402B defines a lower or bottom surface of the deck plate 402 (e.g., a surface underneath the deck 210 that is oriented toward the pit 222). The support members 404 extend between the front header 406 and the rear header 408. The support members 404 extend along at least a portion of the length, L of the deck plate 402 to provide support, strength, and/or rigidity to the deck plate 402. Example channels 410 (e.g., trenches, spaces, gaps, etc.) are formed between adjacent ones of the support members 404 (e.g., along the length, L of the deck 210). In some examples, the rear header 408 can be a unitary header that is cut and/or formed from a sheet of material (e.g., a metal, etc.) and welded or otherwise attached to the deck 210. In some examples, the rear header 408 provides structural support for the deck plate 402. In some examples, the rear header 408 defines the rear edge 212 of the deck 210. Additionally, the rear header 408 of the illustrated example has a length that is substantially equal to the width, W of the deck plate 402. As disclosed herein, a length that is substantially equal to width refers to the length that is within a 10% value of the width. In some examples, the rear header 408 implements a portion (e.g., a deck portion) of the rear hinge assembly 224.

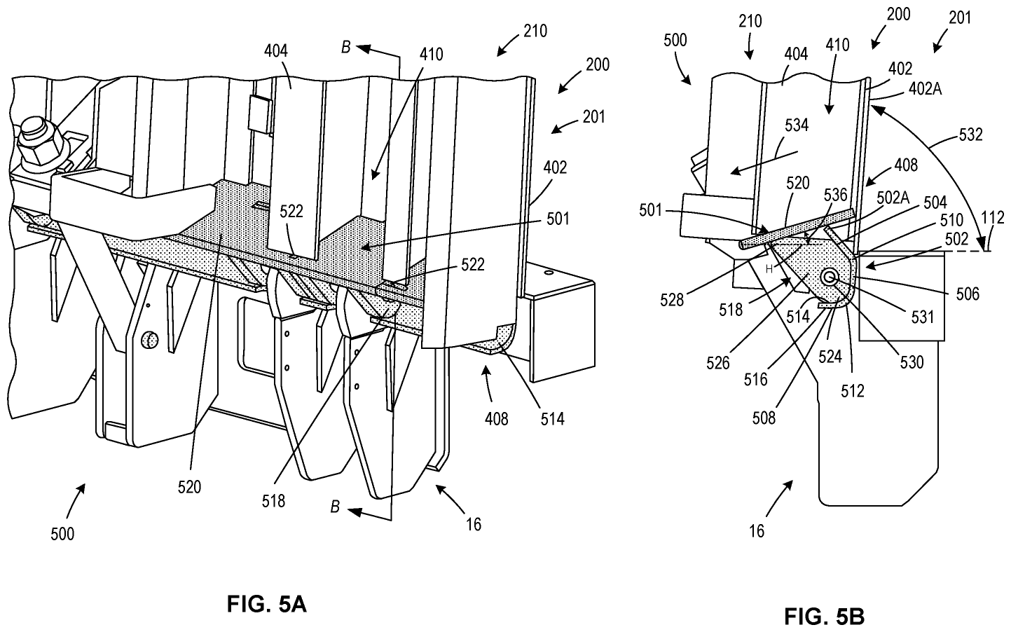

FIG. 5A is a partial perspective view of the dock leveler 200 of FIGS. 2-4 showing a portion of an underside 500 of the dock leveler 200. FIG. 5B is a cross-sectional side view of the underside 500 of the dock leveler 200 taken along a line B-B of FIG. 5A. Referring to FIGS. 5A and 5B, the rear header 408 of the illustrated example includes a tapered or sloped profile 501. The rear header 408 of the illustrated example is a hinge-member such that the rear header 408 helps facilitate coupling of the deck 210 to the frame 16. For example, the rear header 408 includes a mounting plate 502 (e.g., mounting bracket) that can extend along at least a portion of the width W, (FIG. 4) of the deck plate 402 (e.g., the deck 210) to pivotably couple the deck 210 to the frame.

In the illustrated example the mounting plate 502 is a curved mounting plate. For example, the mounting plate 502 of the illustrated example is a formed sheet of material (e.g., a metal sheet) defined by an example first portion 504, an example second portion 506, and an example third portion 508. A first curved portion 510 transitions the first portion 504 and the second portion 506, and a second curved portion 512 transitions the second portion 506 and the third portion 508. The first portion 504, the second portion 506 and the third portion 508 are substantially straight or plate surfaces. The second curved portion 512 has a radius that is greater than a radius of the first curved portion 510 to form an arc between the second portion 506 and the third portion 508. The mounting plate 502 includes an example inner surface 514 and an example outer surface 516.

The rear header 408 of the illustrated example includes example hinge lugs 518 and an example tilt plate 520 (e.g., tilt structure, tilt component, etc.), both of which are coupled to or supported by the mounting plate 502. The tilt plate 520 can include example apertures 522 (e.g., slots) to receive respective ones of the support members 404 (e.g., respective ends of the support members 404). In the illustrated example, the tilt plate 520 extends along the width, W (FIG. 4) of the deck plate 402. The tilt plate 520 is coupled (e.g., welded) to the mounting plate 502 along a first end 502A of the mounting plate 502 (e.g., along an end of the first portion 504).

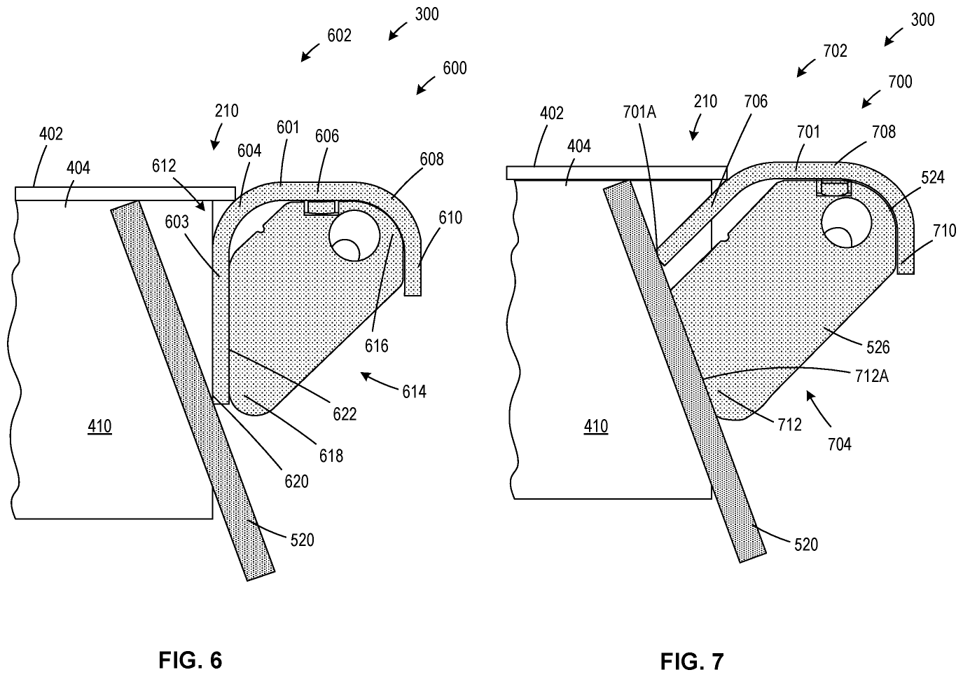

The hinge lugs 518 of the illustrated example each include a crown 524, a body 526, and a foot 528. The crown 524 is rounded and includes a hole 530 to receive a hinge pin 531. The crown 524 can be coupled to at least a portion of the inner surface 514 of the mounting plate 502. Specifically, the inner surface 514 defining at least a portion of the second portion 506, the third portion 508, and the second curved portion 512 receives the crowns 524 of the hinge lugs 518. As illustrated in FIG. 5B, the foot 528 of the illustrated example is coupled to the tilt plate 520. Thus, in the illustrated example, the tilt plate 520 is coupled to the hinge lugs 518 at a first end of the tilt plate 520 (e.g., via the foot 528 of the hinge lugs 518) and the mounting plate 502 at a second end of the tilt plate 520 opposite the first end (e.g., via the first portion 504 of the mounting plate 502). In some examples, the foot 528 can be coupled (e.g., welded, etc.) to the mounting plate 502 (e.g., see FIG. 6).

In some examples, the mounting plate 502 and/or the tilt plate 520 can be formed as a unitary piece or structure having a length substantially equal to the width, W of the deck plate 402. In some examples, the mounting plate 502 and/or the tilt plate 520 includes a plurality of segments positionable between respective ones of the support members 404.

Referring to FIG. 5B, when the dock leveler 200 is in the stored position 201, the deck 210 of the illustrated example has a slight tilt towards the dock floor 112 (FIGS. 1-3) (e.g., a rearward direction 204, FIG. 2). That is, an angle 532 between the loading dock floor 112 (e.g., an upper surface of the loading dock floor 112) and the traffic surface 402A of the deck plate 402 (e.g., an upper surface of the deck plate 402) is at or less than 90 degrees. In some examples, the angle 532 is approximately between 85 degrees and 87 degrees. In other words, the deck plate 402 is slanted more towards the loading dock floor 112 than the pit floor 222A (FIG. 3) relative to a vertical reference. Such a storage configuration reduces pressure on a hydraulic system that actuates the dock leveler 200, helping prolong equipment life.

Referring to FIGS. 5A and 5B, the rear header 408 of the illustrated example prevents or reduces debris accumulation along the rear header 408. For example, the rear header 408 prevents or restricts debris from accumulating within the channels 410 formed between the support members 404. Although the angle 532 between the deck plate 402 and the dock floor 112 is less than ninety degrees, the title plate 520 of the illustrated example is sloped in a direction toward from the dock face 102 (FIGS. 1-3) and/or the toward the pit 222 (FIGS. 2-3) (e.g., and away from the dock floor 112) when the dock leveler 200 is in the stored position 201. That is, the sloped profile 501 of the rear header 408 provides a sloped direction 534 that is a combination of the downward direction 208 (FIG. 2) and the forward 202 (FIG. 2). For example, the sloped profile 501 provides an angle 536 relative to horizontal, H that is approximately between five degrees and 50 degrees. The sloped profile 501 is sloped or tapered toward the floor 222A of the pit 222 to direct debris toward the floor 222A of the pit 222 when the dock leveler 200 is in the stored position 201 and the angle 532 between the deck plate 402 and the loading dock floor 112 is less than ninety degrees relative to the dock floor Thus, the sloped profile 501 (e.g., the tilt plate 520) of the rear header 408 prevents or restricts debris from being caught and/or accumulated by the rear header 408 (e.g., in the channels 410 at the underside 500 of the dock leveler 200).

FIGS. 6 and 7 are different example rear headers 600-700 disclosed herein implemented with dock levelers 602-702. Many of the components of the example dock levelers 602-702 are substantially similar or identical to the components described above in connection with FIGS. 1-4, 5A, and 5B. As such, those components will not be described in detail again below. Instead, the interested reader is referred to the above corresponding descriptions for a complete written description of the structure and operation of such components. To facilitate this process, similar or identical reference numbers will be used for like structures in FIGS. 6 and 7 as used in FIGS. 1-4, 5A, and 5B. For instance, the dock levelers 602-702 include a deck 210, a deck plate 402, support members 404, and one or more channels 410.

FIG. 6 is a partial, cross-sectional side view of the example dock leveler 602 and the example rear header 600. The dock leveler 602 of the illustrated example is shown in an example operating position 300. The rear header 600 of the illustrated example includes a mounting plate 601. The mounting plate 601 of the illustrated example includes an example first portion 603, which is generally straight, an example first curve 604 leading to an example second portion 606, which is generally straight, and an example second curve 608 leading towards an example third portion 610, which is generally straight. The first portion 603 of the illustrated example is substantially perpendicular relative to the deck plate 402. In some examples, the first portion 603 implements a rear edge 612 of the deck 210. The portions 603, 606, 610 define an example curved mounting plate for the rear header 600. The mounting plate 601 is similar to the mounting plate 20 of FIGS. 12A-12B. The rear header 600 of FIG. 6 includes an example tilt plate 520 coupled to the mounting plate 601 to prevent or restrict debris from accumulating on the rear header 600. Specifically, the tilt plate 520 of the illustrated example is attached to the first portion 603 of the mounting plate 601.

The rear header 600 of the illustrated example includes an example hinge lug 614 that includes a crown 616, which is coupled to the second and third portions 606, 610 of the rear header 600 (e.g., the mounting plate 601), and a foot 618, which is coupled to the first portion 603. In the illustrated example of FIG. 6, the hinge lug 614 is not coupled to the tilt plate 520. For example, the tilt plate 520 is coupled to an outer surface 620 of the first portion 603 of the mounting plate 601 and the foot 618 of the hinge lug 614 is coupled to an inner surface 622 of the first portion 603 of the mounting plate 601. In other words, the first portion 603 of the mounting plate 601 is positioned between the tilt plate 520 and the hinge lug 614. As such, the hinge lug 614 is decoupled or spaced from the tilt plate 520 (e.g., the hinge lug 614 is not directly attached to the tilt plate 520 or the hinge lug 614 does not directly engage the tilt plate 520).

FIG. 7 is a partial, cross-sectional side view of the example dock leveler 702 and the example rear header 700. The dock leveler 702 of the illustrated example is shown in an example operating position 300. The rear header 700 of FIG. 7 includes an example mounting plate 701 and an example hinge lug 704. The mounting plate 701 includes an example first portion 706, an example second portion 708, and an example third portion 710. The hinge lug 704 includes a crown 524 and a body 526. The hinge lug 704 of FIG. 7 includes an example foot 712 that is formed to directly engage or couple to a tilt plate 520. For example, the foot 712 has an edge or end surface 712A that is complementary to a surface or profile of the tilt plate 520. In other words, the foot 712 rests on a portion of the tilt plate 520. The tilt plate 520 is coupled to a portion of the foot 712 of the hinge lug 704 and a first end or end surface 701A of the mounting plate 701. In the illustrated example, the end surface 712A engages the tilt plate 520 with a greater amount of surface area than a surface area of the end surface 701A of the mounting plate 701. Such a configuration can provide increased support for the tilt plate 520.

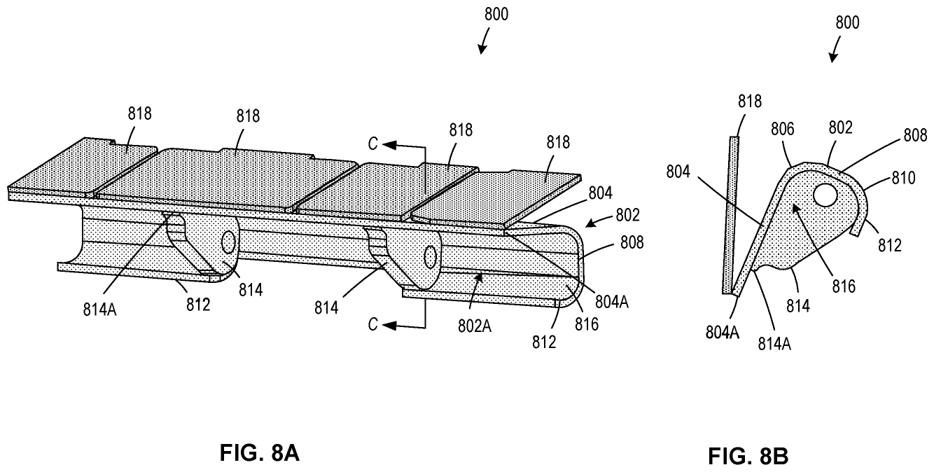

FIGS. 8A and 8B illustrate another example rear header 800 disclosed herein. FIG. 8A is a perspective view of rear header 800. FIG. 8B is a cross-sectional side view of the rear header 800 taken along a line C-C of FIG. 8A. The rear header 800 of FIGS. 8A-8B includes an example mounting plate 802. The mounting plate 802 of the illustrated example includes an example first portion 804, an example first curve 806 leading to an example second portion 808, and an example second curve 810 leading to an example third portion 812. The first portion 804, the second portion 808 and the third portion 812 each has a substantially straight profile. Additionally, the first portion 804 has a longer length than a length of the third portion 812. As illustrated in FIG. 8B, the mounting plate 802 includes a J-shaped cross section. The rear header 800 includes example hinge lugs 814 that are coupled to an inner surface 816 of the mounting plate 802. The mounting plate 802 defines a cavity 802A to receive the hinge lugs 814 such that the mounting plate 802 surrounds or encases the hinge lugs 814. The first portion 804 extends past respective ends 814A of the hinge lugs 814.

The rear header 800 of FIGS. 8A-8B includes a plurality of example tilt plates 818 (e.g., tilt structures, tilt components, etc.). The tilt plates 818 are positioned adjacent the mounting plate 802 between support members of a deck (e.g., the support members 404 of the deck 210 of FIGS. 2-4). In the illustrated example, the tilt plates 818 are welded or otherwise coupled or attached to a first end 804A of the first portion 804 of the mounting plate 802. In some examples, the tilt plates 818 can be positioned between the support members 404 such that the tilt plates 818 remain in position (e.g., via friction or interference fit) without directly attaching or fastening to the mounting plate 802.

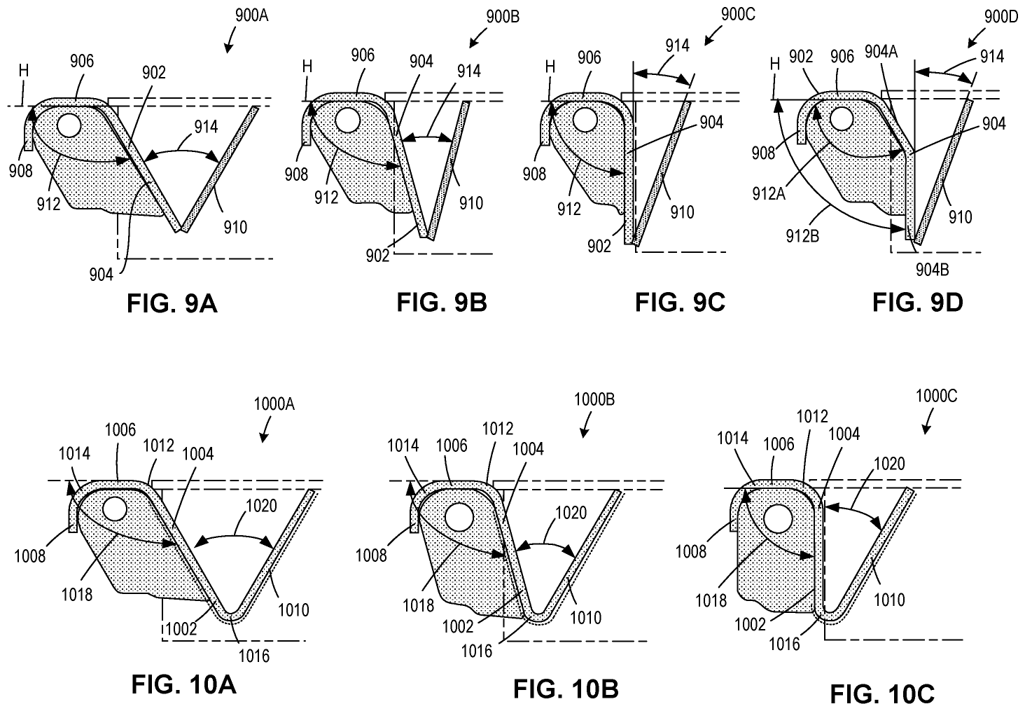

FIGS. 9A-9D are side views of other example rear headers 900A-900D disclosed herein. FIG. 9A illustrates a first example rear header 900A having a mounting plate 902 that includes an example first portion 904 (e.g., first portion 504, 603, 706, 804), an example second portion 906 (e.g., second portion 506, 606, 708, 808), and an example third portion 908 (e.g., the third portion 508, 610, 710, 812). An example tilt plate 910 (e.g., the tilt plate 520, 818) is coupled to the first portion 904 of the mounting plate 902. The second portion 906 and the first portion 904 of the illustrated example form an angle 912 relative to horizontal, H of approximately 120 degrees. The first portion 904 and the tilt plate 910 of the illustrated example form an angle 914 of approximately 60 degrees.

FIG. 9B illustrates a second example rear header 900B in which the first angle 912 defined between the first portion 904 and the second portion 906 relative to horizontal, H is approximately 105 degrees and the second angle 914 defined between the first portion 904 and the tilt plate 910 is approximately 30 degrees.

FIG. 9C illustrates a third example rear header 900C in which the first angle 912 between the first portion 904 and the second portion 906 is approximately 90 degrees relative to horizontal, H and the second angle 914 between the first portion 904 and the tilt plate 910 is approximately 20 degrees.

FIG. 9D illustrates a fourth example rear header 900D in which the first portion 904 is bent to form a first part 904A of the first portion 904 and a second part 904B of the first portion 904 (e.g., where the first part 904A is angled relative to the second part 904B). An angle 912A defined between the first part 904A of the first portion 904 and the second portion 906 is approximately 120 degrees. An angle 912B defined between the second part 904B of the first portion 904 and the second portion 906 is approximately 90 degrees. The second angle 914 defined between the second part 904B of the first portion 904 and the tilt plate 910 is approximately 20 degrees.

FIGS. 10A-10C are side views of other example rear headers 1000A-1000C disclosed herein. The rear headers 1000A-1000C each include an example mounting plate 1002 that includes an example first portion 1004, an example second portion 1006, and an third portion 1008 of the rear headers 1000A-1000C. The mounting plate 1002 is similar to the mounting plates 502, 601, 701, 802, 902 of FIGS. 4-9. However, the mounting plate 1002 of FIGS. 10A-10C includes an example fourth or tilt portion 1010 (e.g., a tilt plate). In other words, the mounting plate 1002 and the tilt plate 1010 are integrally formed as a unitary or single piece structure.

The mounting plate 1002 includes a first curve 1012 between or transitioning the first portion 1004 and the second portion 1006 and a second curve 1014 between or transitioning the second portion 1006 and the third portion 1008. The first and second curves 1012, 1014 are in the same circumferential direction. The mounting plate 1002 includes a third curve 1016 between or transitioning the first portion 1004 and the tilt portion 1010. The third curve 1016 is in another circumferential direction that is opposite the first circumferential direction.

FIG. 10A illustrates a first example rear header 1000A having an example first angle 1018 formed between the first portion 1004 and the second portion 1006 of the mounting plate 1002 of approximately 120 degrees and an example second angle 1020 formed between the first portion 1004 and the tilt portion 1010 of approximately 60 degrees.

FIG. 10B illustrates a second example rear header 1000B having the first angle 1018 formed between the first portion 1004 and the second portion 1006 of approximately 120 degrees and the second angle 1020 formed between the first portion 1004 and the tilt portion 1010 of approximately 45 degrees.

FIG. 10C illustrates a third example rear header 1000C having the first angle 1018 formed between the first portion 1004 and the second portion 1006 of approximately 90 degrees and the second angle 1020 formed between the first portion 1004 and the tilt portion 1010 of approximately 30 degrees.

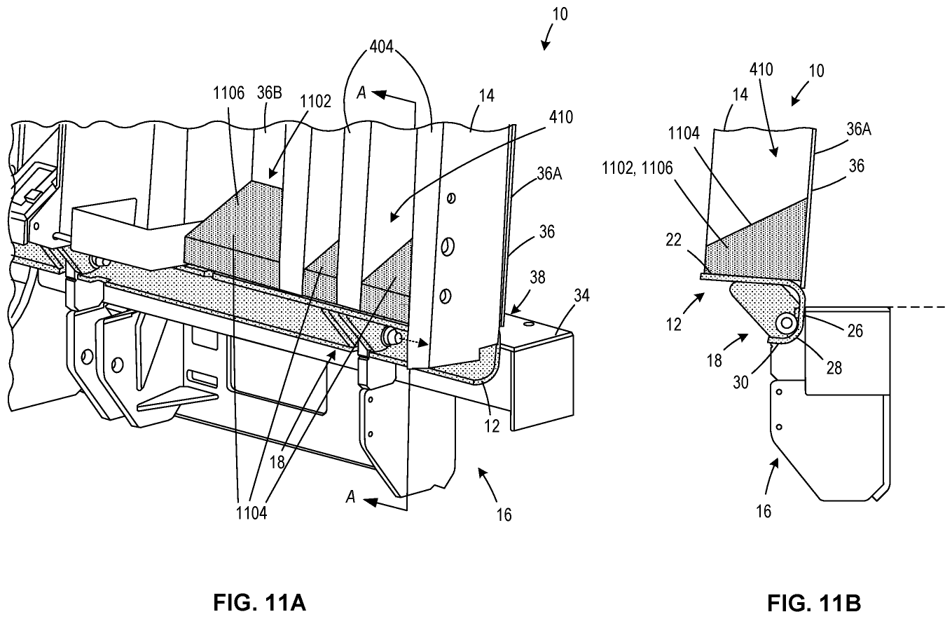

FIG. 11A is a partial, perspective view of the dock leveler 10 of FIG. 12A having an example tilt structure 1102 (e.g., tilt component, etc.) disclosed herein. FIG. 11B is a cross-sectional side view of FIG. 11A. The tilt structure 1102 is a body having a sloped surface 1104. Specifically, the sloped surface 1104 is oriented in a direction away from a rear surface 36B of the deck plate 36. Thus, when the dock leveler 10 is in a stored position, the sloped surface 1104 of the tilt structure 1102 is oriented in a direction away from the rear surface 36B of the deck 14 (e.g., toward the pit 222 of FIG. 2) even though the rear header 12 and/or the mounting plate 20 is sloped toward the rear surface 36B of the deck plate 36.

The tilt structure 1102 of the illustrated example is a wedge 1106 positioned within a channel 410 formed between support members 404 underneath of the deck plate 36. In the illustrated example, the tilt structure 1102 includes a plurality of wedges 1106. For example, the wedges 1106 are positioned within respective ones of the channels 410. The wedges 1106 can be formed of foam, plastic, wood, and/or any other suitable material. In some examples, the wedges 1106 include an outer cover (e.g., a cloth material, a plastic material, etc.) that encases a core body (e.g., a foam body, a plastic body, a wood frame, etc.). The tilt structure 1102 and/or the wedges 1106 can be coupled to the deck 14 via adhesive, interference fit, mounting brackets, fasteners, magnets, and/or any other suitable fastener(s).

The example rear headers 408, 600, 700, 800, 900A-900D and 1000A-1000C and/or the tilt structure 1102 can be coupled to a deck and/or a dock leveler at the manufacturing site and/or can retrofit dock levelers in the field. For example, the 408, 600, 700, 800, 900A-900D and 1000A-1000C and/or the tilt structure 1102 disclosed herein can be retrofit with the deck plate 36 of FIG. 11A.

Although each example rear header 408, 600, 700, 800, 900A-900D and 1000A-1000C, the dock levelers 10, 200, 602, 702, and/or the tilt structure 1102 disclosed above have certain features, it should be understood that it is not necessary for a particular feature of one example rear header 408, 600, 700, 800, 900A-900D and 1000A-1000C, the dock levelers 10, 200, 602, 702, and/or the tilt structure 1102 to be used exclusively with that example. Rather, any of the features of the example rear header 408, 600, 700, 800, 900A-900D and 1000A-1000C, the dock levelers 10, 200, 602, 702, and/or the tilt structure 1102 described above and/or depicted in the drawings can be combined or implemented with any of the example rear header 408, 600, 700, 800, 900A-900D and 1000A-1000C, the dock levelers 10, 200, 602, 702, and/or the tilt structure 1102 in addition to or in substitution for any of the other features of those examples. One example's features are not mutually exclusive to another example's features. Instead, the scope of this disclosure encompasses any combination of any of the features. In some examples, a dock leveler disclosed in accordance with the teachings of this disclosure may have a combination of the features of the example rear headers 408, 600, 700, 800, 900A-900D and 1000A-1000C, the dock levelers 10, 200, 602, 702, and/or the tilt structure 1102 disclosed herein.

From the foregoing, it will be appreciated that example methods, apparatus, and articles of manufacture have been disclosed that provide one or more benefits including preventing debris from collecting in a dock leveler. The example methods, apparatus and articles of manufacture further provide a rear header that provides clear open access to a pit area of a dock leveler. Example rear header disclosed herein include example tilt plates that slop in a direction opposite a tilt of a dock leveler in a stored position. Example tilt plates disclosed herein prevent the example rear headers from becoming debris traps.

At least some of the aforementioned examples include one or more features and/or benefits including, but not limited to, the following:

Example 1 includes a dock leveler comprising a deck movable between a stored position and an operating position; and a rear header coupled to the deck, the rear header including a hinge lug; a mounting plate to couple to the hinge lug, the mounting plate defining a first sloped surface oriented toward a rear surface of the deck when the dock leveler is in the stored position; and a tilt plate coupled to the mounting plate, the tilt plate defining a second sloped surface oriented away from the rear surface of the deck when the dock leveler is in the stored position.

Example 2 includes the dock leveler of example 1, wherein the second sloped surface provides an angle relative to a horizontal of approximately between 5 degrees and 50 degrees when the dock leveler is in the stored position.

Example 3 includes the dock leveler of any one of examples 1-2, wherein the second sloped surface of the tilt plate is to prevent the rear header from accumulating debris when the dock leveler is in the stored position.

Example 4 includes the dock leveler of any one of examples 1-3, wherein the tilt plate extends along a width of the deck.

Example 5 includes the dock leveler of any one of examples 1-4, wherein the dock leveler includes support beams coupled to the deck, and wherein the tilt plate includes slots to receive respective ones of the support beams.

Example 6 includes the dock leveler of any one of examples 1-5, wherein the rear header is a unitary structure formed of sheet of material, the rear header including a first portion, a second portion, and a third portion, and wherein the tilt plate is coupled to the first portion of the rear header.

Example 7 includes the dock leveler of example 6, wherein the tilt plate and the first portion of the rear header form an angle that is between approximately 30 degrees and 90 degrees.

Example 8 includes the dock leveler of any one of examples 1-7, wherein the hinge lug includes a foot, and wherein the tilt plate is coupled to the foot of the hinge lug.

Example 9 includes a dock leveler structured to pivot between a stored position and an operational position, the dock leveler comprising a deck having a deck plate and a plurality of beams extending between a front edge and a rear edge of the deck plate, the deck plate including a first side defining a traffic surface and a second side that is opposite the first side, the beams coupled to the second side of the deck plate; a rear header coupled to the deck, the rear header including a mounting plate that couples to the rear edge of the deck, the mounting plate having a first portion defining a first slope toward the second side of the deck plate when the dock leveler is in the stored position; and a tilt structure, the tilt structure having a second slope oriented away from the second side of the deck plate when the dock leveler is in the stored position.

Example 10 includes the dock leveler of example 9, wherein the tilt structure is a wedge structure.

Example 11 includes the dock leveler of any one of examples 9-10, wherein the tilt structure is a tilt plate.

Example 12 includes the dock leveler of example 11, wherein an angle between the tilt plate and the first portion of the rear header is between approximately 30 degrees and 90 degrees.

Example 13 includes the dock leveler of any one of examples 9-12, further including a hinge lug having a crown and a foot, wherein the crown is coupled to a second portion of the rear header, the second portion extending from the first portion, and wherein the foot is coupled to the tilt structure.

Example 14 includes the dock leveler of any one of examples 9-13, where in the tilt structure is a first tilt structure to be positioned between a first one of the beams and a second one of the beams, and further including a second tilt structure, the second tilt structure to be positioned between the second one of the beams and a third one of the beams.

Example 15 includes the dock leveler of example 14, wherein at least one of the first tilt structure or the second tilt structure is coupled to the rear header.

Example 16 includes a rear header for a dock leveler, the rear header comprising a hinge lug including a crown and a foot; and a mounting plate to engage the hinge lug, the mounting plate including a first portion defining a rear edge of the dock leveler, the first portion to couple to the dock leveler; a second portion curved towards a third portion in a first circumferential direction to define an arc; and a fourth portion, the fourth portion curved away from the first portion in a second circumferential direction, wherein fourth portion is a tilt plate to direct debris away from the rear header.

Example 17 includes the rear header of example 16, wherein the first and fourth portions form an angle that is between approximately 30 degrees and 90 degrees.

Example 18 includes the rear header of any one of examples 16-17, wherein the first and second portions form an angle that is between approximately 90 degrees and 120 degrees.

Example 19 includes the rear header of any one of examples 16-18, wherein at least one of the first portion or the fourth portion includes a slot, the slot to receive a portion of a beam of the dock leveler.

Example 20 includes the rear head of example 19, wherein the rear header is coupled to the dock leveler, the dock leveler including a deck having a deck plate, a front edge, and a rear edge; and wherein the fourth portion is associated with a slope in a direction away from the deck plate and towards the rear edge of the deck.

The following claims are hereby incorporated into this Detailed Description by this reference. Although certain example, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. A dock leveler comprising:
a deck movable between a stored position and an operating position; and
a rear header coupled to the deck, the rear header including:
a hinge lug;
a mounting plate to couple to the hinge lug, the mounting plate defining a first sloped surface oriented toward a rear surface of the deck when the dock leveler is in the stored position; and
a tilt plate coupled to the mounting plate, the tilt plate defining a second sloped surface oriented away from the rear surface of the deck when the dock leveler is in the stored position.

2. The dock leveler of claim 1, wherein the second sloped surface provides an angle relative to a horizontal of approximately between 5 degrees and 50 degrees when the dock leveler is in the stored position.

3. The dock leveler of claim 1, wherein the second sloped surface of the tilt plate is to prevent the rear header from accumulating debris when the dock leveler is in the stored position.

4. The dock leveler of claim 1, wherein the tilt plate extends along a width of the deck.

5. The dock leveler of claim 1, wherein the dock leveler includes support beams coupled to the deck, and wherein the tilt plate includes slots to receive respective ones of the support beams.

6. The dock leveler of claim 1, wherein the rear header is a unitary structure formed of sheet of material, the rear header including a first portion, a second portion, and a third portion, and wherein the tilt plate is coupled to the first portion of the rear header.

7. The dock leveler of claim 6, wherein the tilt plate and the first portion of the rear header form an angle that is between approximately 30 degrees and 90 degrees.

8. The dock leveler of claim 1, wherein the hinge lug includes a foot, and wherein the tilt plate is coupled to the foot of the hinge lug.

9. A dock leveler structured to pivot between a stored position and an operational position, the dock leveler comprising:
a deck having a deck plate and a plurality of beams extending between a front edge and a rear edge of the deck plate, the deck plate including a first side defining a traffic surface and a second side that is opposite the first side, the beams coupled to the second side of the deck plate;
a rear header coupled to the deck, the rear header including a mounting plate that couples to the rear edge of the deck, the mounting plate having a first portion defining a first slope toward the second side of the deck plate when the dock leveler is in the stored position; and
a tilt structure, the tilt structure having a second slope oriented away from the second side of the deck plate when the dock leveler is in the stored position.

10. The dock leveler of claim 9, wherein the tilt structure is a wedge structure.

11. The dock leveler of claim 9, wherein the tilt structure is a tilt plate.

12. The dock leveler of claim 11, wherein an angle between the tilt plate and the first portion of the rear header is between approximately 30 degrees and 90 degrees.

13. The dock leveler of claim 9, further including a hinge lug having a crown and a foot, wherein the crown is coupled to a second portion of the rear header, the second portion extending from the first portion, and wherein the foot is coupled to the tilt structure.

14. The dock leveler of claim 9, where in the tilt structure is a first tilt structure to be positioned between a first one of the beams and a second one of the beams, and further including a second tilt structure, the second tilt structure to be positioned between the second one of the beams and a third one of the beams.

15. The dock leveler of claim 14, wherein at least one of the first tilt structure or the second tilt structure is coupled to the rear header.

16. A rear header for a dock leveler, the rear header comprising:
a hinge lug including a crown and a foot; and
a mounting plate to engage the hinge lug, the mounting plate including:
a first portion defining a rear edge of the dock leveler, the first portion to couple to the dock leveler;
a second portion curved towards a third portion in a first circumferential direction to define an arc; and
a fourth portion, the fourth portion curved away from the first portion in a second circumferential direction, wherein fourth portion is a tilt plate to direct debris away from the rear header.

17. The rear header of claim 16, wherein the first and fourth portions form an angle that is between approximately 30 degrees and 90 degrees.

18. The rear header of claim 16, wherein the first and second portions form an angle that is between approximately 90 degrees and 120 degrees.

19. The rear header of claim 16, wherein at least one of the first portion or the fourth portion includes a slot, the slot to receive a portion of a beam of the dock leveler.

20. The rear head of claim 19, wherein the rear header is coupled to the dock leveler, the dock leveler including a deck having a deck plate, a front edge, and a rear edge; and
wherein the fourth portion is associated with a slope in a direction away from the deck plate and towards the rear edge of the deck.
